(19) United States
(12) Patent Application Publication
(10) Pub. No.: US 2013/0205146 A1
(43) Pub. Date: Aug. 8, 2013

(54) Systems and Methods for Power Governance in a Data Processing Circuit

(71) Applicants: Fan Zhang, Milpitas, CA (US); Yang Han, Sunnyvale, CA (US); Shaohua Yang, San Jose, CA (US); Wu Chang, Santa Clara, CA (US)

(72) Inventors: Fan Zhang, Milpitas, CA (US); Yang Han, Sunnyvale, CA (US); Shaohua Yang, San Jose, CA (US); Wu Chang, Santa Clara, CA (US)

(73) Assignee: LSI Corporation

(21) Appl. No.: 13/369,069

(22) Filed: Feb. 8, 2012

(51) Int. Cl. G06F 1/32

(52) U.S. Cl. 713/322

(57) ABSTRACT

The present inventions are related to systems and methods for data processing, and more particularly to systems and methods for power governance in a data processing system.

### BACKGROUND OF THE INVENTION

The present inventions are related to systems and methods for data processing, and more particularly to systems and methods for power governance in a data processing system.

Various data transfer systems have been developed including storage systems, cellular telephone systems, radio transmission systems. In each of the systems data is transferred from a sender to a receiver via some medium. For example, in a storage system, data is sent from a sender (i.e., a write function) to a receiver (i.e., a read function) via a storage medium. In some cases, the data processing function uses a variable number of iterations depending upon the characteristics of the data being processed. The variable number of processing iterations result in ambiguity in determining circuit power requirements, and can require the choice of an expensive packaging designed to dissipate power at a higher rate than may actually be required.

Hence, for at least the aforementioned reasons, there exists a need in the art for advanced systems and methods for data processing.

### BRIEF SUMMARY OF THE INVENTION

The present inventions are related to systems and methods for data processing, and more particularly to systems and methods for power governance in a data processing system.

Various embodiments of the present invention provide data processing systems that include: an iterative data processing circuit and a power governing circuit. The iterative data processing circuit is operable to apply a modifiable number iterations of a processing algorithm to a data input synchronous to a modifiable clock to yield a data output. The modifiable number of iterations may be selected between at least a first number of iterations and a second number of iterations with the second number of iterations being less than the first. The modifiable clock is selected between at least a full rate clock and a reduced rate clock. In some cases, the full rate clock exhibits and average frequency that is greater than the reduced rate clock. In one particular case, the peak frequency of the full rate clock is the same as that of the reduced rate clock. The power governing circuit is operable to determine a power usage level that is above a threshold, and upon determining that the power usage level is above a threshold, and to select the reduced rate clock as the modifiable clock and the second number of iterations as the modifiable number of iterations. In some instances of the aforementioned embodiments, the data processing system is implemented as an integrated circuit. In various instances of the aforementioned embodiments, the data processing system is incorporated in a storage device, or a data communication device.

In one or more instances of the aforementioned embodiments, selecting the reduced rate clock reduces the rate of processing through the iterative data processing circuit, and selecting the second number of iterations at least in part offsets the reduction in the rate of processing through the data processing circuit. In some embodiments of the present invention, the iterative data processing circuit includes a data detector circuit operable to apply a data detection algorithm to the data input to yield a detected output, and a data decoding circuit operable to apply a data decode algorithm to the detected output to yield the data output. In some such instances, the modifiable number iterations is the number of allowed global iterations through both the data detector circuit and the data decoder circuit. In other instances, the modifiable number iterations is the number of allowed local iterations through the data decoding circuit between applications of the data detection algorithm by the data detection circuit. In various instances, selecting the reduced rate clock results in use of the reduced rate clock by the data decoding circuit and the full rate clock by the data detector circuit. In other instances, selecting the reduced rate clock results in use of the reduced rate clock by the data detector circuit and the full rate clock by the data decoding circuit. In yet other instances, selecting the reduced rate clock results in use of the reduced rate clock by both the data detector circuit and the data decoding circuit.

In various instances of the aforementioned embodiments, the power governing circuit includes a power monitor circuit and a throughput preservation and clock rate reduction circuit. The power monitor circuit is operable to compare the power usage level with the threshold to determine whether the power usage level is above the threshold. The throughput preservation and clock rate reduction circuit operable to preserve throughput by selecting the second number of iterations as the modifiable number of iterations, and to reduce the average power used by the iterative data processing circuit by selecting the reduced rate clock as the modifiable clock.

Other embodiments of the present invention provide methods for data processing that include: providing a iterative data processing circuit; determining a power usage level of the data processing circuit; comparing the power usage level against a threshold; and based at least in part on the power usage level being greater than the threshold, selecting a reduced rate clock for use by the iterative data processing circuit, and reducing a number of allowable iterations of the iterative data processing circuit. In some instances of the aforementioned embodiments, the methods further include selecting a full rate clock for use by the iterative data processing circuit, and increasing the number of allowable iterations of the iterative data processing circuit based at least in part on the power usage level being less than the threshold. In some such instance, the reduced rate clock exhibits an average frequency that is less than the full rate clock.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 shows a storage system including throughput preservation and clock rate reduction power control circuitry in accordance with various embodiments of the present invention;

FIG. 2 depicts a data transmission system including throughput preservation and clock rate reduction power control circuitry in accordance with one or more embodiments of the present invention;

FIG. 3 shows a data processing circuit including throughput preservation and clock rate reduction power control circuitry in accordance with some embodiments of the present invention;

FIG. 4a is a flow diagram showing a method for variable data processing through data decoder and data detection circuitry; and

FIG. 4b is a flow diagram showing a method for throughput preservation and clock rate reduction power control for use in conjunction with the method of FIG. 4a in accordance with some embodiments of the present invention.

### DETAILED DESCRIPTION OF THE INVENTION

The present inventions are related to systems and methods for data processing, and more particularly to systems and methods for power governance in a data processing system.

Various embodiments of the present invention provide for power governance in a variable data processing system. As an example, a variable data processing system may include one or more data detector circuits and one or more data decoder circuits with the output of a data detector circuit being passed to a data decoder circuit for processing. At various operational times too many of the data detector circuits and/or data decoder circuits may be operating in parallel such that power usage of the overall circuit exceeds an acceptable level. Such excessive power usage can result in processing errors or other more catastrophic faults. To mitigate this possibility, a power level monitoring circuit is employed that provides a reasonable estimate of current power utilization by the overall circuit. When an excessive power utilization condition is identified, the clock rate used to synchronize processing through one or more of the data detector circuits and data decoder circuits is reduced. Such a change in clock rate reduces the power usage of the overall circuit. While the clock rate is reduced in the circuit, a minimum throughput of data being requested by a host controller is maintained. This is done by reducing a number of iterations allowed through the data detector circuits and/or data decoder circuits.

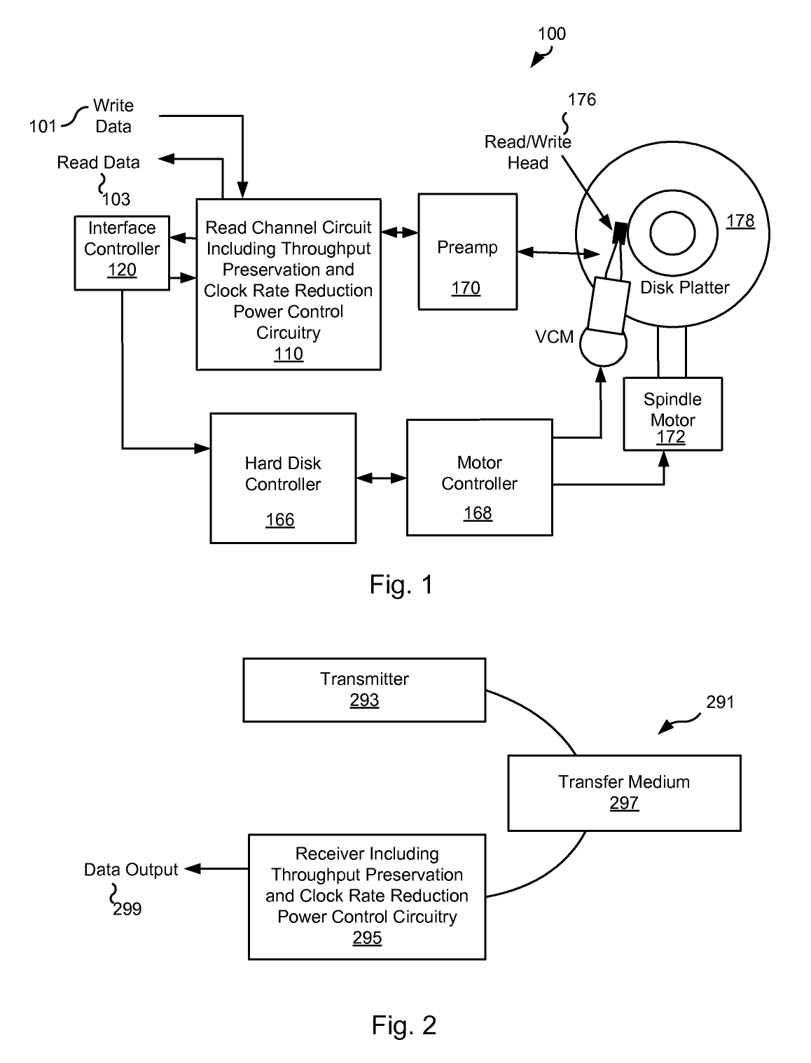

Turning to FIG. 1, a storage system 100 including a read channel circuit 110 including throughput preservation and clock rate reduction power control circuitry is shown in accordance with various embodiments of the present invention. Storage system 100 may be, for example, a hard disk drive. Storage system 100 also includes a preamplifier 170, an interface controller 120, a hard disk controller 166, a motor controller 168, a spindle motor 172, a disk platter 178, and a read/write head 176. Interface controller 120 controls addressing and timing of data to/from disk platter 178. The data on disk platter 178 consists of groups of magnetic signals that may be detected by read/write head assembly 176 when the assembly is properly positioned over disk platter 178. In one embodiment, disk platter 178 includes magnetic signals recorded in accordance with either a longitudinal or a perpendicular recording scheme.

In a typical read operation, read/write head assembly 176 is accurately positioned by motor controller 168 over a desired data track on disk platter 178. Motor controller 168 both positions read/write head assembly 176 in relation to disk platter 178 and drives spindle motor 172 by moving read/write head assembly to the proper data track on disk platter 178 under the direction of hard disk controller 166. Spindle motor 172 spins disk platter 178 at a determined spin rate (RPMs). Once read/write head assembly 176 is positioned adjacent the proper data track, magnetic signals representing data on disk platter 178 are sensed by read/write head assembly 176 as disk platter 178 is rotated by spindle motor 172. The sensed magnetic signals are provided as a continuous, minute analog signal representative of the magnetic data on disk platter 178. This minute analog signal is transferred from read/write head assembly 176 to read channel circuit 110 via preamplifier 170. Preamplifier 170 is operable to amplify the minute analog signals accessed from disk platter 178. In turn, read channel circuit 110 decodes and digitizes the received analog signal to recreate the information originally written to disk platter 178. This data is provided as read data 103 to a receiving circuit. A write operation is substantially the opposite of the preceding read operation with write data 101 being provided to read channel circuit 110. This data is then encoded and written to disk platter 178.

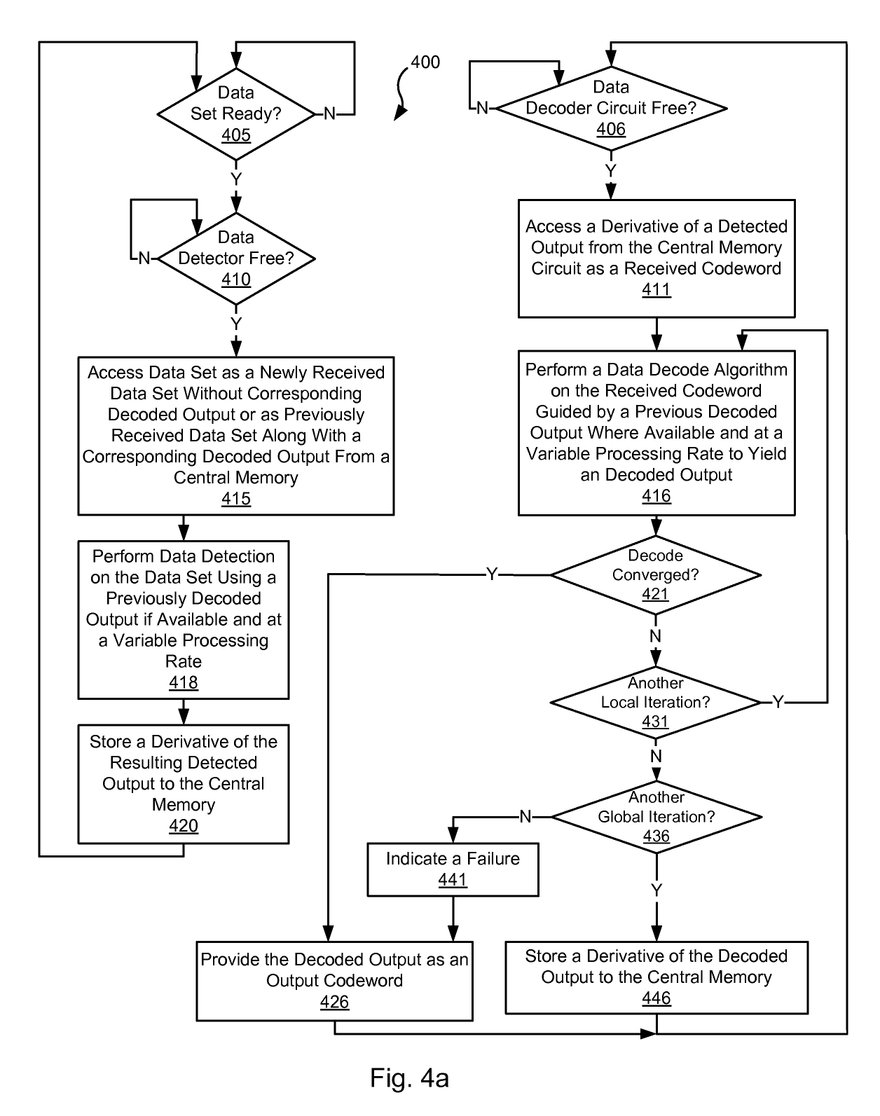

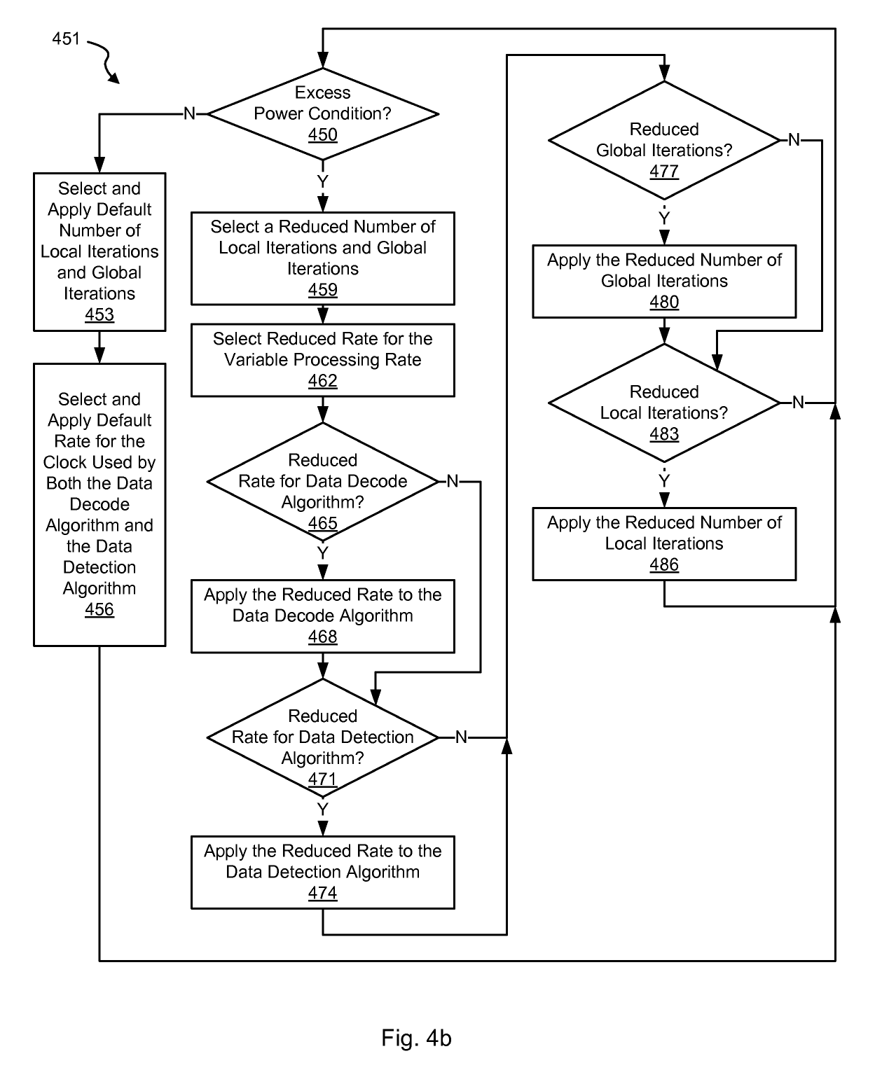

As part of processing the received information, read channel circuit 110 utilizes a variable data processing circuit that allows different portions of data to utilize different amounts of processing bandwidth and different combinations of data detector and/or data decoder circuits. Where too many data decoding or data detection circuits are used at the same time, an excessive power utilization condition may arise. Where such an excessive power condition is detected, the clock rate used to synchronize processing through one or more of the data detector circuits and data decoder circuits is reduced. Such a change in clock rate reduces the power usage of the overall circuit. While the clock rate is reduced in the circuit, it is important to maintain a minimum throughput of data available as read data 103 so that any impact on a host (not shown) is limited. To do this, the number of iterations through the data detector circuits and/or data decoder circuits is also reduced. This combination of processes yields a reduction in power usage while maintaining a minimum throughput of data available as read data. The data processing circuit may be implemented similar to that discussed below in relation to FIG. 3, and/or may operate using an approach similar to that discussed below in relation to FIGS. 4a-4b.

It should be noted that storage system 100 may be integrated into a larger storage system such as, for example, a RAID (redundant array of inexpensive disks or redundant array of independent disks) based storage system. Such a RAID storage system increases stability and reliability through redundancy, combining multiple disks as a logical unit. Data may be spread across a number of disks included in the RAID storage system according to a variety of algorithms and accessed by an operating system as if it were a single disk. For example, data may be mirrored to multiple disks in the RAID storage system, or may be sliced and distributed across multiple disks in a number of techniques. If a small number of disks in the RAID storage system fail or become unavailable, error correction techniques may be used to recreate the missing data based on the remaining portions of the data from the other disks in the RAID storage system. The disks in the RAID storage system may be, but are not limited to, individual storage systems such as storage system 100, and may be located in close proximity to each other or distributed more widely for increased security. In a write operation, write data is provided to a controller, which stores the write data across the disks, for example by mirroring or by striping the write data. In a read operation, the controller retrieves the data from the disks. The controller then yields the resulting read data as if the RAID storage system were a single disk.

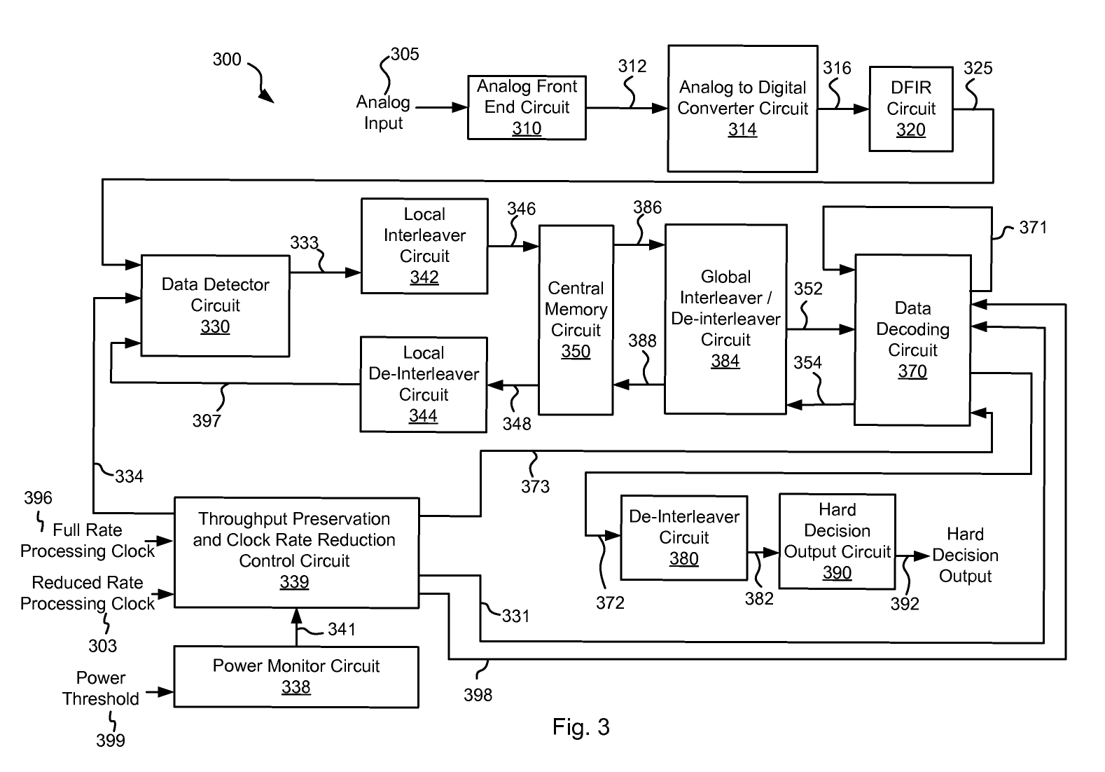

Turning to FIG. 2, a data transmission system 291 including a receiver 295 having throughput preservation and clock rate reduction power control circuitry is shown in accordance with various embodiments of the present invention. Data transmission system 291 includes a transmitter 293 that is operable to transmit encoded information via a transfer medium 297 as is known in the art. The encoded data is received from transfer medium 297 by a receiver 295. Receiver 295 processes the received input to yield the originally transmitted data. Receiver 295 provides the processed data as a data output 299 to a host (not shown).

As part of processing the received information, receiver 295 utilizes a variable data processing circuit that allows different portions of data to utilize different amounts of processing bandwidth and different combinations of data detector and/or data decoder circuits. Where too many data decoding or data detection circuits are used at the same time, an excessive power utilization condition may arise. Where such an excessive power condition is detected, the clock rate used to synchronize processing through one or more of the data detector circuits and data decoder circuits is reduced. Such a change in clock rate reduces the power usage of the overall circuit. While the clock rate is reduced in the circuit, it is important to maintain a minimum throughput of data available as data output 299 so that any impact on a host (not shown) is limited. To do this, the number of iterations through the data detector circuits and/or data decoder circuits is also reduced. This combination of processes yields a reduction in power usage while maintaining a minimum throughput of data available as read data. The data processing circuit may be implemented similar to that discussed below in relation to FIG. 3, and/or may operate using an approach similar to that discussed below in relation to FIGS. 4a-4b.

FIG. 3 shows a data processing circuit 300 including throughput preservation and clock rate reduction power control circuitry in accordance with some embodiments of the present invention. Data processing circuit 300 includes an analog front end circuit 310 that receives an analog signal 305. Analog front end circuit 310 processes analog signal 305 and provides a processed analog signal 312 to an analog to digital converter circuit 314. Analog front end circuit 310 may include, but is not limited to, an analog filter and an amplifier circuit as are known in the art. Based upon the disclosure provided herein, one of ordinary skill in the art will recognize a variety of circuitry that may be included as part of analog front end circuit 310. In some cases, analog signal 305 is derived from a read/write head assembly (not shown) that is disposed in relation to and senses data maintained on a storage medium (not shown). In other cases, analog signal 305 is derived from a receiver circuit (not shown) that is operable to receive a signal from a transmission medium (not shown). The transmission medium may be wired or wireless. Based upon the disclosure provided herein, one of ordinary skill in the art will recognize a variety of source from which analog input 305 may be derived.

Analog to digital converter circuit 314 converts processed analog signal 312 into a corresponding series of digital samples 316. Analog to digital converter circuit 314 may be any circuit known in the art that is capable of producing digital samples corresponding to an analog input signal. Based upon the disclosure provided herein, one of ordinary skill in the art will recognize a variety of analog to digital converter circuits that may be used in relation to different embodiments of the present invention. Digital samples 316 are provided to an equalizer circuit 320. Equalizer circuit 320 applies an equalization algorithm to digital samples 316 to yield an equalized output 325. In some embodiments of the present invention, equalizer circuit 320 is a digital finite impulse response filter circuit as are known in the art. In some cases, equalizer 320 includes sufficient memory to maintain one or more codewords until processing of that codeword is completed through a data detector circuit 330 and a data decoding circuit 370 including, where warranted, multiple global iterations (passes through both data detector circuit 330 and data decoding circuit 370) and/or local iterations (passes through data decoding circuit 370 during a given global itertation). It may be possible that equalized output 325 may be received directly from a storage device in, for example, a solid state storage system. In such cases, analog front end circuit 310, analog to digital converter circuit 314 and equalizer circuit 320 may be eliminated where the data is received as a digital data input.

Data detector circuit 330 may be a single data detector circuit or may be two or more data detector circuits operating in parallel on different codewords. Whether it is a single data detector circuit or a number of data detector circuits operating in parallel, data detector circuit 330 is operable to apply a data detection algorithm to a received codeword or data set. In some embodiments of the present invention, data detector circuit 330 is a Viterbi algorithm data detector circuit as are known in the art. In other embodiments of the present invention, data detector circuit 330 is a is a maximum a posteriori data detector circuit as are known in the art. Of note, the general phrases “Viterbi data detection algorithm” or “Viterbi algorithm data detector circuit” are used in their broadest sense to mean any Viterbi detection algorithm or Viterbi algorithm detector circuit or variations thereof including, but not limited to, bi-direction Viterbi detection algorithm or bi-direction Viterbi algorithm detector circuit. Also, the general phrases “maximum a posteriori data detection algorithm” or “maximum a posteriori data detector circuit” are used in their broadest sense to mean any maximum a posteriori detection algorithm or detector circuit or variations thereof including, but not limited to, simplified maximum a posteriori data detection algorithm and a max-log maximum a posteriori data detection algorithm, or corresponding detector circuits. Based upon the disclosure provided herein, one of ordinary skill in the art will recognize a variety of data detector circuits that may be used in relation to different embodiments of the present invention. In some cases, one data detector circuit included in data detector circuit 330 is used to apply the data detection algorithm to the received codeword for a first global iteration applied to the received codeword, and another data detector circuit included in data detector circuit 330 is operable apply the data detection algorithm to the received codeword guided by a decoded output accessed from a central memory circuit 350 on subsequent global iterations. Data detector circuit 330 applies the data detection algorithm at a rate governed by a variable rate clock 334.

Upon completion of application of the data detection algorithm to the received codeword on the first global iteration, data detector circuit 330 provides a detector output 333. Detector output 333 includes soft data. As used herein, the phrase “soft data” is used in its broadest sense to mean reliability data with each instance of the reliability data indicating a likelihood that a corresponding bit position or group of bit positions has been correctly detected. In some embodiments of the present invention, the soft data or reliability data is log likelihood ratio data as is known in the art. Detected output 333 is provided to a local interleaver circuit 342. Local interleaver circuit 342 is operable to shuffle sub-portions (i.e., local chunks) of the data set included as detected output and provides an interleaved codeword 346 that is stored to central memory circuit 350. Interleaver circuit 342 may be any circuit known in the art that is capable of shuffling data sets to yield a re-arranged data set. Interleaved codeword 346 is stored to central memory circuit 350.

Once a data decoding circuit 370 is available, a previously stored interleaved codeword 346 is accessed from central memory circuit 350 as a stored codeword 386 and globally interleaved by a global interleaver/de-interleaver circuit 384. Global interleaver/De-interleaver circuit 384 may be any circuit known in the art that is capable of globally rearranging codewords. Global interleaver/De-interleaver circuit 384 provides a decoder input 352 into data decoding circuit 370. In some embodiments of the present invention, the data decode algorithm applied by data decoding circuit 370 is a low density parity check algorithm as are known in the art. Based upon the disclosure provided herein, one of ordinary skill in the art will recognize other decode algorithms that may be used in relation to different embodiments of the present invention. Data decoding circuit 370 applies a data decode algorithm to decoder input 352 to yield a decoded output 371 at a rate governed by a variable rate clock 373. In cases where another local iteration (i.e., another pass trough data decoder circuit 370) is desired, data decoding circuit 370 re-applies the data decode algorithm to decoder input 352 guided by decoded output 371. This continues until either a maximum number of local iterations as indicated by a local iteration control 331 exceeded or decoded output 371 converges.

Where decoded output 371 fails to converge (i.e., fails to yield the originally written data set) and a number of local iterations through data decoder circuit 370 exceeds a threshold indicated by local iteration control 331, the resulting decoded output is provided as a decoded output 354 back to central memory circuit 350 if a maximum number of global iterations as indicated by a global iteration control 398 has not been exceeded. In this case, decoded output 354 is stored awaiting another global iteration through a data detector circuit included in data detector circuit 330. Prior to storage of decoded output 354 to central memory circuit 350, decoded output 354 is globally de-interleaved to yield a globally de-interleaved output 388 that is stored to central memory circuit 350. The global de-interleaving reverses the global interleaving earlier applied to stored codeword 386 to yield decoder input 352. When a data detector circuit included in data detector circuit 330 becomes available, a previously stored de-interleaved output 388 accessed from central memory circuit 350 and locally de-interleaved by a de-interleaver circuit 344. De-interleaver circuit 344 re-arranges decoder output 348 to reverse the shuffling originally performed by interleaver circuit 342. A resulting de-interleaved output 397 is provided to data detector circuit 330 where it is used to guide subsequent detection of a corresponding data set previously received as equalized output 325.

Alternatively, where the decoded output 371 fails to converge and the number of local iterations indicated by local iteration control 331 and the number of global iterations indicated by global iteration control 398 have exceeded their respective limits, an error is generated indicating a failure to converge by data decoding circuit 370. As yet another alternative, where decoded output 371 converges (i.e., yields the originally written data set), the resulting decoded output is provided as an output codeword 372 to a de-interleaver circuit 380. De-interleaver circuit 380 rearranges the data to reverse both the global and local interleaving applied to the data to yield a de-interleaved output 382. De-interleaved output 382 is provided to a hard decision output circuit 390. Hard decision output circuit 390 is operable to re-order data sets that may complete out of order back into their original order. The originally ordered data sets are then provided as a hard decision output 392.

A power monitor circuit 338 monitors current drawn by data processing circuit 300, and compares that current with a power threshold 399. Power monitor circuit 338 may be any circuit known in the art that is capable of approximating a power usage by an associated circuit and providing an indication of the approximated power usage. Power threshold 399 may be a user programmable value that is set at a power level where acceptable operation of data processing circuit 300 can be assured. In other cases, power threshold 399 is a fixed value. Where power monitor circuit 338 determines that current drawn by data processing circuit 300 exceeds power threshold 399, power status signal 341 is asserted high. Otherwise, power status signal 341 is asserted low. Based upon the disclosure provided herein, one of ordinary skill in the art will recognize a variety of circuits that may be used to implement power monitor circuit in accordance with different embodiments of the present invention.

A throughput preservation and clock rate reduction power control circuit 339 monitors power status signal 341, and based thereon modifies the rate of detector clock 334 and/or decoder clock 373, and modifies the number of local iterations and/or global iterations by changing local iteration control 331 and/or global iteration control 398. In particular, where power status signal 341 is asserted low indicating that power usage is within an acceptable range, throughput preservation and clock rate reduction power control circuit 339 selects a full rate processing clock 396 as data detector clock 334 and data decoder clock 373, and selects a default number of global iterations and a default number of local iterations and provides the selection as global iteration control 398 and local iteration control 331, respectively.

Alternatively, where power status signal 341 is asserted low indicating that power usage is above an acceptable range, throughput preservation and clock rate reduction power control circuit 339 selects a reduced rate processing clock 303 one or both of data detector clock 334 and data decoder clock 373. Of note, in some embodiments of the present invention, only data decoder clock 373 is reduced to the rate of reduced rate clock 303, while data detector clock 334 remains at the rate of full rate clock 396. In other embodiments of the present invention, only data detector clock 334 is reduced to the rate of reduced rate clock 303, while data decoder clock 373 remains at the rate of full rate clock 396. In yet other embodiments of the present invention, both data decoder clock 373 and data detector clock 334 are reduced to the rate of reduced rate clock 303.

In addition, where power status signal 341 is asserted low throughput preservation and clock rate reduction power control circuit 339 reduces the number of local iterations allowed by data decoding circuit 370 and/or the number of global iterations allowed through both data detector circuit 330 and data decoding circuit 370. In one particular embodiment of the present invention, the number of allowed global iterations as indicated by global iteration control 398 is maintained constant when power status signal 341 is asserted low, and the number of allowed local iterations is reduced as indicated by local iteration control 398. In some cases, the number of allowed local iterations is reduced from seven to two. The reduction in the number of iterations is selected to reduce the amount of time that a codeword is allowed to process through data decoder circuit 370 to offset the increase in processing time applied to codewords due to a reduction in the rate of the processing clock. Based upon the disclosure provided herein, one of ordinary skill in the art will recognize a variety of reductions in the number of local iterations that may be done in accordance with different embodiments of the present invention.

In other embodiments of the present invention, the number of allowed local iterations as indicated by local iteration control 331 is maintained constant when power status signal 341 is asserted low, and the number of allowed global iterations is reduced as indicated by global iteration control 331. This would cause a codeword to be identified as processing complete before it is normally kicked out of the processing system. In some cases, the default number of global iterations is variable and based on the number of iterations used by concurrently processing codewords. By adding a hard limit to the number of global iterations, processing codewords are kicked out on a maximum fixed schedule reducing the amount of time they stay in the system before being reported to the host. Again, the reduction in the number of iterations is selected to reduce the amount of time that a codeword is allowed to process through data detector circuit 330 and data decoder circuit 370 to offset the increase in processing time applied to codewords due to a reduction in the rate of the processing clock.

In yet other embodiments of the present invention, both the number of local iterations and the number of global iterations are reduced. In any case, by reducing the number of iterations that may be applied to any given codeword, the time that a codeword is allowed to continue processing through data detector circuit 330 and data decoder circuit 370 is reduced. This reduction in time at least in part offsets the reduced clock rate used in processing through one or both of data decoder circuit 330 and data detector circuit 370. Thus, by reducing both the number of iterations that may be applied to a particular codeword and the clock rate at which the codewords are processed, a reduction in power usage by data processing circuit 300 is achieved (i.e., through reducing the rate of the processing clock) while maintaining an throughput of codewords (i.e., by reducing the iterations that a codeword may utilize) through the system expected by a host (not shown).

Turning to FIG. 4a, a flow diagram 400 shows a process for variable data processing through a data detector circuit and a data decoder circuit. Following flow diagram 400, it is determined whether a data set is ready for application of a data detection algorithm (block 405). In some cases, a data set is ready when it is received from a data decoder circuit via a central memory circuit. In other cases, a data set is ready for processing when it is first made available from an front end processing circuit. Where a data set is ready (block 405), it is determined whether a data detector circuit is available to process the data set (block 410).

Where the data detector circuit is available for processing (block 410), the data set is accessed by the available data detector circuit (block 415). The data detector circuit may be, for example, a Viterbi algorithm data detector circuit or a maximum a posteriori data detector circuit. Where the data set is a newly received data set (i.e., a first global iteration), the newly received data set is accessed. In contrast, where the data set is a previously received data set (i.e., for the second or later global iterations), both the previously received data set and the corresponding decode data available from a preceding global iteration (available from a central memory) is accessed. The accessed data set is then processed by application of a data detection algorithm to the data set (block 418). The data detection is performed at a variable processing rate that is more fully described below. Where the data set is a newly received data set (i.e., a first global iteration), it is processed without guidance from decode data available from a data decoder circuit. Alternatively, where the data set is a previously received data set (i.e., for the second or later global iterations), it is processed with guidance of corresponding decode data available from preceding global iterations. Application of the data detection algorithm yields a detected output. A derivative of the detected output is stored to the central memory (block 420). The derivative of the detected output may be, for example, an interleaved or shuffled version of the detected output.

In parallel to the previously described data detection process, it is determined whether a data decoder circuit is available (block 406). The data decoder circuit may be, for example, a low density data decoder circuit as are known in the art. Where the data decoder circuit is available (block 406), a previously stored derivative of a detected output is accessed from the central memory and used as a received codeword (block 411). A data decode algorithm is applied to the received codeword to yield a decoded output (block 416). The data decode algorithm is performed at a variable processing rate that is more fully described below. Where a previous local iteration has been performed on the received codeword, the results of the previous local iteration (i.e., a previous decoded output) are used to guide application of the decode algorithm. It is then determined whether the decoded output converged (e.g., resulted in the originally written data) (block 421). Where the decoded output converged (block 421), it is provided as a decoded output (block 426).

Alternatively, where the decoded output failed to converge (e.g., errors remain) (block 421), it is determined whether another local iteration is desired (block 431). In some cases, as a default seven local iterations are allowed per each global iteration. As more fully discussed below, this number of local iterations may be reduced where an excessive power condition is identified. Based upon the disclosure provided herein, one of ordinary skill in the art will recognize another default number of local iterations that may be used in relation to different embodiments of the present invention. Where another local iteration is desired (block 431), the processes of blocks 406-431 are repeated for the codeword.

Alternatively, where another local iteration is not desired (block 431), it is determined whether an other global iteration is allowed (block 436). As a default, another global iteration is allowed where there is sufficient available space in the central memory and an output memory reordering queue to allow another pass through processing the currently processing codeword. The amount of available space in the central memory and an output memory reordering queue is a function of how many iterations are being used by concurrently processing codewords to converge. For more detail on the output queue time limitation see, for example, U.S. patent application Ser. No. 12/114,462 entitled “Systems and Methods for Queue Based Data Detection and Decoding”, and filed May 8, 2008 by Yang et al. The entirety of the aforementioned reference is incorporated herein by reference for all purposes. Thus, the amount of time that a codeword may continue processing through global iterations is a function of the availability of central memory and an output memory reordering queue. By limiting the number of global iterations that may be performed, the amount of time a codeword may continue processing through global iterations can be reduced.

Where another global iteration is allowed (block 436), a derivative of the decoded output is stored to the central memory (block 436). The derivative of the decoded output being stored to the central memory triggers the data set ready query of block 405 to begin the data detection process. Alternatively, where another global iteration is not allowed (block 436), a failure to converge is indicated (block 441), and the current decoded output is provided (block 426).

In some embodiments of the present invention during the aforementioned data decoding and data detection processing described above in relation to FIG. 4a, the clock provided to one or both of the data detection circuit or the data decoding circuit may be varied to control power usage by the circuit, and the number of iterations may be varied to maintain a minimum codeword throughput as described in relation a flow diagram 451 of FIG. 4b. Following flow diagram 451, it is determined whether an excess power condition exists (block 450). This excess power condition may be determined by measuring current peak power usage or average power usage by a semiconductor device by a circuit designed to perform such an analysis, and comparing the measured value with a threshold value.

Where an excess power condition does not exist (block 450), a default number of local iterations and global iterations are selected and applied (block 453). Selecting the default number affects the number of global iterations and local iterations allowed in blocks 431, 436 of flow diagram 400 discussed above. In some cases, the default number of local iterations is seven, and the default number of global iterations is unlimited. Based upon the disclosure provided herein, one of ordinary skill in the art will recognize other number of global iterations and local iterations that may be used in relation to different embodiments of the present invention.

In addition, a default rate for a clock used for the data detection algorithm of block 418 and a default rate for a clock used to the data decode algorithm of block 416 are selected and applied (block 456). Selection and application of the default rate may be done, for example, by selecting a full rate clock, or by using all clock cycles of a processing clock. Based upon the disclosure provided herein, one of ordinary skill in the art will recognize a variety of approaches for selecting and applying a default rate clock that may be used in relation to different embodiments of the present invention.

Alternatively, where an excess power condition does exist (block 450), a reduced number of local iterations and a reduced number of global iterations are selected (block 459), and a reduced processing rate is selected (block 462). It is determined whether the reduced processing rate is to be used in relation to the data decode algorithm (block 465). This selection may be user selectable or hard coded. Where it is to be used in relation to the data decode algorithm (block 465), the reduced rate clock is applied to the data decode algorithm (block 468). Reducing the rate of the clock reduces the processing rate of the data decode of block 416 and the average amount of power consumed in the processing. The reduced rate clock may operate at a lower frequency than a default full rate clock, or it may include one or more clock cycles gated from the full rate clock to yield a reduction in the average frequency. It is then determined whether the reduced processing rate is to be used in relation to the data detection algorithm (block 471). This selection may be user selectable or hard coded. Where it is to be used in relation to the data detection algorithm (block 471), the reduced rate clock is applied to the data detection algorithm (block 474). Reducing the rate of the clock reduces the processing rate of the data detection of block 418 and the average amount of power consumed in the processing.

It is then determined whether the number of global iterations is to be reduced (block 477). This selection may be user selectable or hard coded. Where the number of global iterations is to be reduced (block 477), the previously selected reduced number of global iterations is applied (block 480). This modifies the operation of block 436 of flow diagram 400 by changing the threshold for determining whether another global iteration is allowed. It is then determined whether the number of local iterations is to be reduced (block 483). This selection may be user selectable or hard coded. Where the number of local iterations is to be reduced (block 483), the previously selected reduced number of local iterations is applied (block 486). This modifies the operation of block 431 of flow diagram 400 by changing the threshold for determining whether another local iteration is allowed.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, the invention provides novel systems, devices, methods and arrangements for power governance. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A data processing system, the data processing system comprising:
an iterative data processing circuit operable to apply a modifiable number iterations of a processing algorithm to a data input synchronous to a modifiable clock to yield a data output, wherein the modifiable number of iterations is selected from a group consisting of: a first number of iterations, and a second number of iterations; and wherein the modifiable clock is selected from a group consisting of: a full rate clock, and a reduced rate clock; and
a power governing circuit operable to:
determine a power usage level, wherein the power usage level is above a threshold;
upon determining that the power usage level is above a threshold, select the reduced rate clock as the modifiable clock and the second number of iterations as the modifiable number of iterations, wherein the second number of iterations is less than the first number of iterations.

2. The data processing system of claim 1, wherein selecting the reduced rate clock reduces the rate of processing through the iterative data processing circuit, and wherein selecting the second number of iterations at least in part offsets the reduction in the rate of processing through the data processing circuit.

3. The data processing system of claim 1, wherein the iterative data processing circuit comprises:
a data detector circuit operable to apply a data detection algorithm to the data input to yield a detected output;
a data decoding circuit operable to apply a data decode algorithm to the detected output to yield the data output; and
wherein the modifiable number iterations is the number of allowed global iterations through both the data detector circuit and the data decoder circuit.

4. The data processing system of claim 1, wherein the iterative data processing circuit comprises:
a data detector circuit operable to apply a data detection algorithm to the data input to yield a detected output;
a data decoding circuit operable to apply a data decode algorithm to the detected output to yield the data output; and
wherein the modifiable number iterations is the number of allowed local iterations through the data decoding circuit between applications of the data detection algorithm by the data detection circuit.

5. The data processing system of claim 4, wherein selecting the reduced rate clock results in use of the reduced rate clock by the data decoding circuit and the full rate clock by the data detector circuit.

6. The data processing system of claim 4, wherein selecting the reduced rate clock results in use of the reduced rate clock by the data detector circuit and the full rate clock by the data decoding circuit.

7. The data processing system of claim 4, wherein selecting the reduced rate clock results in use of the reduced rate clock by both the data detector circuit and the data decoding circuit.

8. The data processing system of claim 1, wherein the data processing circuit comprises:
a data detector circuit operable to apply a data detection algorithm to the data input to yield a detected output, wherein the data detector circuit is selected from a group consisting of: a maximum a posteriori data detector circuit, and a Viterbi algorithm data detector circuit; and
a data decoding circuit operable to apply a data decode algorithm to the detected output to yield the data output.

9. The data processing system of claim 1, wherein the data processing circuit comprises:
a data detector circuit operable to apply a data detection algorithm to the data input to yield a detected output; and
a low density parity check decoder circuit operable to apply a data decode algorithm to the detected output to yield the data output.

10. The data processing system of claim 1, wherein the power governing circuit comprises:
a power monitor circuit operable to compare the power usage level with the threshold to determine whether the power usage level is above the threshold; and
a throughput preservation and clock rate reduction circuit operable to:
preserve throughput by selecting the second number of iterations as the modifiable number of iterations, and to reduce the average power used by the iterative data processing circuit by selecting the reduced rate clock as the modifiable clock.

11. The data processing system of claim 1, wherein the reduced rate clock exhibits an average frequency that is less than the full rate clock.

12. The data processing system of claim 8, wherein the reduced rate clock exhibits the same peak frequency as the full rate clock.

13. The data processing system of claim 1, wherein the data processing system is implemented as an integrated circuit.

14. The data processing system of claim 1, wherein the data processing system is incorporated in a device selected from a group consisting of: a storage device, and a data communication device.

15. A method for data processing, the method comprising:
providing a iterative data processing circuit;
determining a power usage level of the data processing circuit;
comparing the power usage level against a threshold; and
based at least in part on the power usage level being greater than the threshold, selecting a reduced rate clock for use by the iterative data processing circuit, and reducing a number of allowable iterations of the iterative data processing circuit.

16. The method of claim 15, wherein the method further comprises:
based at least in part on the power usage level being less than the threshold, selecting a full rate clock for use by the iterative data processing circuit, and increasing the number of allowable iterations of the iterative data processing circuit.

17. The method of claim 16, wherein the reduced rate clock exhibits an average frequency that is less than the full rate clock.

18. The method of claim 15, wherein selecting the reduced rate clock reduces an average power usage by the iterative data processing circuit, and reducing a number of allowable iterations of the iterative data processing circuit at least in part offset the reduction in throughput due to selecting the reduced rate clock.

19. The method of claim 15, wherein the iterative data processing circuit comprises:
a data detector circuit operable to apply a data detection algorithm to the data input to yield a detected output;
a data decoding circuit operable to apply a data decode algorithm to the detected output to yield the data output; and
wherein the number of allowable iterations of the iterative data processing circuit is selected from a group consisting of: a number of allowed global iterations through both the data detector circuit and the data decoder circuit, and a number of allowed local iterations through the data decoding circuit between applications of the data detection algorithm by the data detection circuit.

20. A storage device, the storage device comprising:
a storage medium;
a head assembly disposed in relation to the storage medium and operable to provide a sensed signal corresponding to information on the storage medium;
a read channel circuit including:
an analog to digital converter circuit operable to sample an analog signal derived from the sensed signal to yield a series of digital samples;
an equalizer circuit operable to equalize the digital samples to yield a first data set;
an iterative data processing circuit operable to apply a modifiable number iterations of a processing algorithm to a data input synchronous to a modifiable clock to yield a data output, wherein the modifiable number of iterations is selected from a group consisting of: a first number of iterations, and a second number of iterations; and wherein the modifiable clock is selected from a group consisting of: a full rate clock, and a reduced rate clock; and
a power governing circuit operable to:
determine a power usage level, wherein the power usage level is above a threshold;
upon determining that the power usage level is above a threshold, select the reduced rate clock as the modifiable clock and the second number of iterations as the modifiable number of iterations, wherein the second number of iterations is less than the first number of iterations.
